(19) United States
(12) Patent Application Publication
(10) Pub. No.: US 2018/0228146 A1
(43) Pub. Date: Aug. 16, 2018

(54) INSECTICIDAL COMPOSITION AND METHOD

(71) Applicant: Zelam Limited, New Plymouth (NZ)

(72) Inventors: Hemant Kumar, New Plymouth (NZ); David Leo Press, Norfolk (GB); Gordon William Harris, Napier (NZ); Wallace James Rae, New Plymouth (NZ); Christopher Molloy, New Plymouth (NZ)

(73) Assignee: Zelam Limited, New Plymouth (NZ)

(21) Appl. No.: 15/515,193

(22) PCT Filed: Oct. 6, 2015
(86) PCT No.: PCT/NZ2015/050171

§ 371 Date: Mar. 29, 2017

(30) Foreign Application Priority Data
Oct. 8, 2014 (NZ) 700774

(51) Int. Cl. A01N 25/28; A01N 25/00; A01N 57/12; A01N 57/14; A01N 57/16; A01N 53/00; A01N 47/24

(52) U.S. Cl. CPC A01N 25/28; A01N 25/006; A01N 57/12; A01N 47/24; A01N 57/16; A01N 53/00; A01N 57/14

(57) ABSTRACT

This invention provides for a solid, particulate insecticidal formulation in the form of a granule, a bait or a tablet for mechanical incorporation into or onto soil comprising a volatile insecticidal active ingredient that is microencapsulated and combined with a bulking agent and a disintegrating agent. The solid particulate formulation is characterized in that the volatile insecticide is selected from insecticidal active ingredients having: (a) a vapour pressure at 25° C. in the range from about 1 mPa to about 1,000 mPa; and (b) a water solubility at 25° C. less than about 100 mg/Litre.

### BACKGROUND

This invention relates to an insecticidal composition, to its method of preparation, and to its method of use.

Broad spectrum insecticides such as the organophosphates chlorpyrifos and chlorpyrifos-methyl are commonly used to control insect pests in agriculture and horticulture. Both compounds are acetylcholinesterase inhibitors with significant mammalian toxicity. Chlorpyrifos, in particular, is still widely used because it controls a broad range of insect pests effectively and economically. These insecticides are applied to aerial plant parts to control above-ground insects, and to soil to control soil-dwelling insects or insect life stages.

Chlorpyrifos is a non-systemic insecticide with contact, disgestive and respiratory action (The Pesticide Manual, 13th Edition, British Crop Protection Manual). Although chlorpyrifos is non-systemic, the relatively high volatilization of the chemical produces substantial dispersion and penetration both above and below ground. This “vapour phase activity” makes chlorpyrifos particularly effective at control of soil-inhabiting herbivorous insects responsible for deterioration of newly planted and established pastures and crops.

Insecticides may be administered to the soil environment by various means including surface application, and spraying or drilling into the furrow during cultivation, sowing or transplant operations. A solid formulation of insecticide drilled into soil “down the spout” along with seed is particularly advantageous producing an even distribution of the insecticide in the seed zone within the soil.

The most widely practiced method of preparing pesticides for soil incorporation involves absorption of a solution of pesticide in an organic solvent onto calcined clay or other inert absorbent carriers. While the resulting products are dimensionally stable, the active ingredient capacity generally is limited to 10-15% by weight, and typically they contain volatile and/or toxic solvents. Alternatively, a suspension or dispersion of active ingredient together with sticking agents and stabilisers can be coated onto an impermeable carrier comprising sand, limestone, etc. This process can involve costly drying and requires precise control of coating conditions. With both approaches surfactants may be added to provide a crude means of controlling active ingredient release. In a further variation powdered forms of solid active ingredients are mixed with water and edible base products such as wheat or bran, together with binders, preservatives and waterproofing agents, then extruded and dried to produce a pellet larger than about 1 mm in diameter. These may be crushed to produce smaller chips.

An important consideration when preparing an insecticide formulation to be mechanically incorporated into or onto soil is that the formulation should be robust enough to withstand handling without breaking up, disintegrating or otherwise being damaged.

The vapour phase activity of compounds like chlorpyrifos is an important aspect of their insecticidal mode of action. Unfortunately volatilization results in active ingredient losses during storage and a significant danger to transport and field operators. Accordingly safer and more stable solid formulations of volatile insecticides are required for use in soil.

Microencapsulation of volatile pesticides is a well-known in the art. Generally, microencapsulation of a volatile pesticide involves enclosing the pesticide in a polymeric material. Microencapsulation is a means of providing increased user safety and reducing volatility (see examples in H. B. Scher, M. Rodson and K-S. Lee, 1998, “Microencapsulation of Pesticides by Interfacial Polymerization Utilizing Isocyanate or Aminoplast Chemistry”, Pesticide Science 54, 394-400 and references therein.

Granulation of microencapsulated insecticides including chlorpyrifos is also known. Generally this is performed by spray drying to form a water dispersible granule, for example LORSBAN™ 75 WG, which is described in U.S. Pat. No. 5,925,464, which is hereby incorporated by reference. In one instance as described in U.S. Pat. No. 4,696,822, which is hereby incorporated by reference, a water dispersible granule is formed by spray drying followed by an agglomeration process. The purpose of a water dispersible granule of this type is to form dilute aqueous suspensions of microcapsules in the field that may be sprayed onto foliage or other insect pest habitats such as wooden structures, etc. In another instance described in U.S. Pat. No. 6,797,277, which is hereby incorporated by reference, a microencapsulated herbicide in liquid form is mixed with dry ingredients to form a water dispersible granule, however this granule does not address the problem of protecting pastures and crops from insect damage, and the granule is not directed to soil application.

Vapour phase activity is an essential requirement for chlorpyrifos efficacy in the soil. While microencapsulation is an effective means of improving worker safety, the reduction in volatility is often counterproductive to insecticidal efficacy in a soil environment.

All references, including any patents or patent applications cited in this specification are hereby incorporated by reference. The applicant makes no admission that any reference constitutes prior art—they are merely assertions by their authors and the applicant reserves the right to contest the accuracy, pertinence and domain of the cited documents. None of the documents or references constitutes an admission that they form part of the common general knowledge in NZ or in any other country.

### SUMMARY

It is an object of the invention to provide an improved insecticidal composition and/or preparative method thereof and/or use thereof which will obviate or minimize one or more of the previously mentioned disadvantages of the prior art, or which will at least provide the public with a useful choice when it comes to treating planted seeds, growing plants and mature plants from soil dwelling insect pests. In particular, the composition is a solid formulation that is stable that can be used for incorporation into soil or for application onto the surface of soil.

Broadly stated the invention relates to a composition comprising a volatile insecticidal active ingredient that is microencapsulated and combined with a bulking agent and a disintegrating agent to produce a solid, particulate formulation formulated so that it may be mechanically incorporated into or onto soil. The solid particulate formulation is characterized in that the volatile insecticide is selected from insecticidal active ingredients having:

(a) a vapour pressure at 25° C. in the range from about 1 mPa to about 1,000 mPa; and
(b) a water solubility at 25° C. less than about 100 mg/Litre.

In a further embodiment of the present invention, the formulation further contains a binding agent, and/or a dispensing agent.

In another aspect of the present invention, the formulation further contains a rheology modifier.

In an aspect of the present invention, the formulation is formulated in the form of a granule, a bait, or a tablet.

In yet another aspect of the present invention, the volatile insecticidal active ingredient is selected from chlorethoxyfos, chlorpyrifos, chlorpyrifos-methyl, diazinon, dichlorvos, disulfoton, fenitrothion, fenthion, phorate, pirimiphos-methyl, tebupirimfos, tefluthrin, terbufos, thiodicarb, and a mixture thereof. The microencapsulated volatile insecticide has a mean microcapsule diameter from about 100 nm to about 1,000 μm in one aspect and in the range of about 200 nm to about 50 μm in a further aspect and more than about 500 nm to about 20 μm in yet a further aspect of the present invention.

In a further embodiment for the previously mentioned embodiments and aspects, the formulation contains a blend of two or more microcapsules, each containing a different active ingredient.

In yet another embodiment, the formulation contains up to 50% by weight of insecticidal active ingredient of the total weight of the granule.

In further embodiments, the bulking agent is selected from clays, starches, lactose, calcium carbonate, calcium sulphate, calcium phosphate, and a mixture thereof; and the disintegrating agent is selected from microcrystalline cellulose, sodium starch glycolate, crosslinked PVP, sodium sulphate, sodium citrate, polycarboxylates, sodium phenylsulphonates, and a mixture thereof.

In yet another embodiment, the binding agent is selected from polyvinyl alcohol, polyvinyl pyrrolidone, polyvinyl acetate copolymers, polyacrylate, gelatine, polyacrylamide, oligosaccharides, sugar alcohols, lecithin, and a mixture thereof and the dispersing agent is selected from calcium, aluminium or sodium lignosulfonate, sodium naphthalene sulfonate, polymeric dispersants, and a mixture thereof.

In yet a further embodiment, the formulation contains a rheology modifier selected from magnesium aluminium silicates, xanthan gum, methyl cellulose, ethyl cellulose, and a mixture thereof.

The solid formulation will generally contain 10-80% by weight of the bulking agents, and 2-20% by weight of the disintegrating agents.

The solid formulation may further contain 2-20% by weight of the binding agents and 2-20% by weight of the dispersing agents.

The solid formulation may further contain 0.1-15% by weight of the rheology modifiers,

Also provided by the present invention is a method for producing a solid particulate insecticidal formulation of at least one of the previous aspect and embodiments. The method contains the steps of:

(A) Preparing a suspension by combining components comprising a microencapsulated volatile insecticide, wherein the volatile insecticide is selected from insecticidal active ingredients having:
(a) a vapour pressure at 25° C. in the range from about 1 mPa to about 1,000 mPa, and
(b) a water solubility at 25° C. less than about 100 mg/Litre;
i. a binding agent;
ii. a dispersing agent; and
iii. optionally a rheology modifier.
(B) Preparing a dry mixture by combining and thoroughly mixing dry ingredients comprising:
a. a bulking agent; and
b. a disintegrating agent;
(C) Combining the microcapsule suspension (A) and the dry mixture (B) and mixing to produce a homogeneous moist mass;
(D) Extruding the homogeneous moist mass (C) to a diameter ranging from about 0.2 mm about 5 mm to form an extruded mass; and
(E) Reducing the moisture content of the extruded mass by drying.

In a further embodiment of the method, the step of dry mixture (B) optionally further comprises a dry binding agent and/or a dry dispersing agent with the bulking agent and the disintegrating agent.

In a further aspect of the method of producing the solid particulate insecticidal formulation, the method further contains spheronizing the extruded mass obtained at step (D) prior to drying.

In another embodiment of the present invention, there is provided is a method of treating soil to minimise insect attack on crops or pasture seeds or pasture plants by incorporating into the soil or applying onto the soil a solid particulate insecticidal formulation according previous embodiments and aspects. In a further aspect the formulation is applied at a rate of application ranges from about 200 grams gai/ha to about 3,000 gai/ha. The formulation is applied at the time of drilling or planting, or at any subsequent stage of the crop or pasture growth cycle.

Microencapsulation is employed to reduce the volatility of the insecticidal active ingredient(s) and hence to improve long term retention of the active ingredient(s) during storage and/or to improve operator safety.

Surprisingly, despite the reduced volatility of the microencapsulated insecticide, the insecticidal efficacy of the solid, particulate formulation is unexpectedly high and retained over a long period of time. As a result, the total application of insecticide on an annual basis can be lowered making crop and pasture maintenance and establishment systems more economic, while minimising or eliminating one or more of the previously mentioned problems.

### DETAILED DESCRIPTION

This invention relates generally to one or more volatile insecticides microencapsulated then formulated for mechanical incorporation into or onto the soil as a granule, a bait or a tablet, in order to provide safer and more effective control of soil dwelling insects.

Unless defined otherwise, all technical and scientific terms used herein have the same meaning as commonly understood by one of ordinary skill in the art to which this invention belongs—and would be readily determined by the ordinarily skilled practitioner by reasonable trial and error, without the need for invention.

The term “insecticidal” encompasses all insect growth controlling or modifying effects including, but not limited, to killing, injury, retarding, stunting of growth, disorientation, inhibition of reproduction, and the like.

The term “insecticidally effective amount” indicates the quantity or application rate of an insecticidal composition which, when applied to the pest habitat, will kill or substantially injure a significant portion of the pest population residing therein, and/or substantially reduce damage to crops or pasture at any stage of the crop growth cycle. The terms insecticidal and insecticidally amount relate to soil dwelling insects in this disclosure.

The term “soil dwelling insect” refers to insects that spend a portion, for example larval stages, or all of their life cycle within the soil. The term includes insects that reside or shelter in soil but feed above ground.

A “microcapsule” is defined as a vessel approximating a sphere of average diameter between about 100 nm and about 1000 μm, comprising a discrete droplet bounded by a physical wall or membrane and containing the active ingredients of interest. Examples of microcapsules and the process of microencapsulation are provided in the description and examples below.

A “dry ingredient” is defined as an ingredient with a moisture content less than 20% by weight, generally less than 10% by weight, typically less than about 7.5% by weight.

Formulation types suitable for this invention are defined in the Catalogue of Pesticide Formulation Types and International Coding System, Technical Monograph No 2, 6th Ed, May 2008, CropLife International, as follows:

Granule (GR): a free-flowing solid formulation of a defined granule size range ready for use;
Bait (ready for use) (RB, hereinafter termed “bait”): a formulation designed to attract and be eaten by the target pests; and
Tablet (TB): pre-formed solids of uniform shape and dimensions, usually circular, with either flat or convex faces, the distance between faces being less than the diameter.

There exists a specialized formulation Encapsulated Granule (CG): a granule with a protective or granule release-controlling coating. The term “Encapsulated” in this context refers to a protective coating surrounding the entire granule and is not to be confused with the use disclosed in the present invention of a “microencapsulated” insecticide as a constituent within the granule. The encapsulated granule formulation type is not the subject of this invention.

Note also that the Granule formulation type (GR) of the present invention is intended for soil incorporation and therefore is distinct from and not to be confused with other granule formulation types including Water dispersible granule (WG), Water soluble granule (SG) and Emulsifiable granule (EG), all of which are formulated for the purpose of introducing the pesticidal active ingredient into water (by dispersing, dissolving, or emulsifying as an oil-in-water emulsion, respectively).

Soil incorporation as used in herein excludes introducing water dispersible granules, water soluble granules or emulsifiable granules into water and then spraying the dilution into or onto soil. In particular, the composition is a granule for incorporation into or onto soil. It is not a granule for use with water or any other form of granule.

Volatility is a function of the vapour pressure of the active ingredient and its solubility in water. Volatilization rates increase with increasing vapour pressure and decrease with increasing water solubility.

Insecticidal active ingredients suitable for the invention have a vapour pressure at 25° C. in the range from about 1 mPa to about 1,000 mPa, have a water solubility at 25° C. less than about 100 mg/Litre, and are soluble in a water-immiscible solvent appropriate for microencapsulation as described below. Generally the vapour pressure of the insecticidal active ingredients is in the range from about 1 mPa to about 250 mPa.

Suitable active ingredients include but are not limited to chlorethoxyfos, chlorpyrifos, chlorpyrifos-methyl, diazinon, dichlorvos, disulfoton, fenitrothion, fenthion, phorate, pirimiphos-methyl, tebupirimfos, tefluthrin, terbufos and thiodicarb. In addition mixtures of these active ingredients may be used. Excluded from the active ingredients are soil fumigants such as methyl bromide, dichloropropane, propylene oxide and the like.

Optionally the microencapsulated volatile insecticidal active ingredient may be supplemented with a different insecticidal active ingredient having a mode of action other than vapour phase activity. Typically the supplementary active ingredient is root absorbed and systemically active, and is soluble in a water-immiscible solvent appropriate for microencapsulation.

Of particular interest in the present invention as the microencapsulated active ingredients of the composition are:

chlorpyrifos (O,O-diethyl O-3,5,6-trichloro-2-pyridyl phosphorothioate), and chlorpyrifos-methyl (O,O-dimethyl O-3,5,6-trichloro-2-pyridyl phosphorothioate). Chlorpyrifos is of the most interest.

Physical properties of chlorpyrifos (The Pesticide Manual, 13th Edition).

| Molecular weight | 350.57 | |
|---|---|---|
| Form | Colourless crystals, mild | |
| | mercaptan odour | |
| Melting point | 42-43.5° | C. |
| Vapour pressure at 25° C. | 2.7 | mPa |
| K_{ow} logP | 4.7 | |
| Henry's law constant at 25° C. | 6.76 × 10⁻¹ | Pa m³ mol⁻¹ |
| Specific gravity (20° C.) | 1.44 | |
| Solubility water (25° C.) | 1.4 | mg/litre |
| Benzene (25° C.) | 7900 | g/kg |
| Acetone (25° C.) | 6500 | g/kg |
| Chloroform (25° C.) | 6300 | g/kg |
| Carbon disulfide (25° C.) | 5900 | g/kg |
| Diethyl ether (25° C.) | 5100 | g/kg |
| Xylene (25° C.) | 5000 | g/kg |
| Iso-octanol (25° C.) | 790 | g/kg |
| Methanol (25° C.) | 450 | g/kg |
| Stability | Rate of hydrolysis increases | |
| | with pH | |
| DT50 (water, pH 8, 25° C.) | 1.55 | d |
| DT50 (phosphate buffer, pH 7, 15° C.) | 100 | d |

The composition may comprise 0.1% to 50% active ingredient(s) by weight of the final solid, particulate formulation. The percentages of active ingredients in the composition will depend mainly on the particular solid formulation type and intended methods of application and use.

Generally the formulation contains from 5% to 40% based on the weight of insecticidal active ingredient. Typically the formulation contains from 10% to 30% based on the weight of insecticidal active ingredient.

Suitable methods for the manufacture of microcapsulated biocides and the manufacture of solid formulations and the uses of such formulations are described more generally, for example, in “Chemistry and Technology of Agrochemical Formulations”, 1998, D. A. Knowles (editor), Kluwer Academic Publishers, “Pesticide Formulation and Adjuvant Technology”, 1996, C. L. Foy (editor), CRC Press, and “Formulation Technology: Emulsions, Suspensions, Solid Forms”, 2001, H. Mollet and A. Grubenmann, Wiley-VCH.

According to one embodiment the microcapsule comprises a core containing the insecticide as a liquid, a gel or suspension of solids, wherein the insecticide in the core is melted, or alternatively dissolved or suspended in a water-immiscible solvent (commonly called the “organic phase”), and wherein the core is enclosed within a microcapsule wall separating the contents from the external phase, usually water (“aqueous phase”).

According to another embodiment the microcapsule wall polymer is produced by interfacial polymerisation of direct acting, complementary reactants, one from the internal (organic) phase and its complimentary counterpart from the external (or aqueous) phase of the microcapsule. Such resulting wall polymers include a polyurea, polyamide, polysulfonamide, polyester, polycarbonate, polyurethane, etc.

According to another embodiment the microcapsule wall polymer is formed by hydrolysis of the organic soluble reactant at the interface to form one or more water-soluble intermediates required for completion of the final wall polymer, e.g. the interfacial hydrolysis of isocyanates to form amines which in turn undergo condensation polymerisation with further isocyanates to form a polyurea wall polymer (Scher et al, 1998, op. cit.)

According to a further embodiment the microcapsule wall comprises a polymerised amino resin formed from an organic-soluble amino resin pre-polymer, such as a low MW butylated urea-formaldehyde pre-polymer, reacted at the organic-water interface by strong acid catalysis.

According to a yet further embodiment the microcapsule wall comprises a polymer deposited at the surface of the interface by coacervation. For example, the insecticidal active ingredient is dissolved in an oil phase then dispersed with vigorous mixing into a solution of gelatine at 40-50° C., then a third phase comprising a solution of gum Arabic or acacia is mixed in before acidifying to a pH of 4.0-5.0 using a weak polyanionic organic acid. The polymeric wall may strengthened by crosslinking using glutaraldehyde.

The product of the microencapsulation process may be used directly in subsequent processes, as shown in the examples, but it is advantageous to formulate a stable aqueous suspension of microcapsules (known as a “capsule suspension”), for use in producing the solid, particulate formulation of the invention.

In some situations it may be useful to dry the microcapsule suspension before further processing, in which case it may be desirable to provide a secondary wall according to known methods in order to stabilise or otherwise alter the properties of the microcapsule.

According to an embodiment, in the method of manufacture microencapsulation is performed by interfacial condensation polymerisation as follows:
(a) an organic phase is prepared by melting the insecticide or dissolving the insecticide in a suitable water-immiscible solvent, and adding a reactive pre-polymer soluble in the melted insecticide and/or water-immiscible solvent (hereafter called the “organic-soluble pre-polymer”), and optionally further dissolving or adding chemical and physical stabilising agents appropriate for the active ingredient, and, optionally a catalyst;
(b) an aqueous phase is prepared containing surfactants, one or more protective colloids, dispersing agents, and optionally a buffer adjusted to provide an appropriate pH;
(c) an aqueous solution of the water-soluble crosslinking agent is prepared;
(d) the organic phase (a) is emulsified in the aqueous phase (b) by mechanical shear wherein the shear force is adjusted to produce stable droplets of the desired diameter;
(e) the aqueous solution of crosslinking agent (c) is added to the stable emulsion and the mixture is agitated gently until interfacial condensation polymerisation is substantially complete.

Water immiscible solvents suitable for preparing the organic phase include the molten volatile insecticide, aromatic non-polar solvents (C6 to C9), naphthalene derivatives, aliphatic non-polar solvents, oils, esterified oils and water insoluble esters. Gentle heating is most often required to produce molten insecticide and may assist in preparation of the completed organic phase with or without additional solvents. An optional additional, systemic insecticide may be added to the organic phase.

Suitable organic-soluble pre-polymers include isocyanates, organic-soluble acid dichlorides, epoxy resins, etc. Generally the organic-soluble pre-polymer of step (a) is a polymeric isocyanate, added to a concentration in the organic phase ranging from about 5 g/kg to about 150 g/kg, generally ranging from about 10 kg to about 125 kg, typically ranging from about 20 g/kg to about 100 g/kg.

Suitable isocyanates include polymeric diphenylmethane diisocyanate (pMDI), dicyclohexylmethane diisocyanate (DMDI), toluene diisocyanate (TDI), isophorone diisocyanate (IPDI), and hexamethylene diisocyanate (HDI).

The organic phase may be modified by the addition of tackifying agents such as aromatic or aliphatic hydrocarbon resins, low molecular weight polyisobutylene resins and similar organic soluble polymers, in order to increase retention of lethal concentrations of active ingredients in the vicinity of the solid formulation when incorporated into soil.

The microcapsule may also include an internal adjuvant to assist in the transfer of the active ingredient into the target pest. Examples of suitable internal adjuvants include the Break-Thru® series of oil enhancers OE 440, OE 441 and OE 444, each of which is suitable for addition to different kinds of solvents and oils as known in the art.

Suitable water-soluble crosslinking agents include alkyl, cycloalkyl, heterocylic and aryl compounds containing two or more amine, alcohol, ether, aldehyde, ketone, acid, ester, acid anhydride, acyl chloride, alkene, alkyne, epoxide, groups and derivatives thereof.

Generally the water-soluble crosslinking agent is an amine or an alcohol, added to a concentration in the aqueous phase from about 1 g/kg to about 360 g/kg, typically ranging from about 5 g/kg to about 180 g/kg, depending on the required stoichiometry of reaction.

Suitable amines include diethylenetriamine (DETA), ethylenediamine (ED), diethyltoluenediamine (DETDA), and tetraethylenepentamine (TEPA).

Suitable alcohols include ethylene glycol (EG), diethylene glycol (DEG), polyethylene glycol 400 (PEG 400), propylene glycol (PG) and glycerol. Generally an organobismuth or organozinc catalyst is added to the organic phase when forming a polyurethane (isocyanate-alcohol) microcapsule wall.

Suitable protective colloids include for example polyvinyl alcohol, polyvinyl pyrrolidone, polyvinyl acetate copolymers, polyacrylate, gelatine, polyacrylamide, and lecithin suspended or dissolved at a concentration of 1-15% by weight. The protective colloids listed above function as binding agents when combined with the mixture of dry ingredients used to prepare the solid composition of the invention.

Dispersing agents suitable for the aqueous phase include but are not limited to calcium, aluminium or sodium lignosulfonate, sodium naphthalene sulfonate, polymeric dispersants including acrylic graft copolymer surfactants such as Tersperse 2500 and Atlox 4913, polyacrylate copolymers such as the Agrilan 700 series, and mixtures thereof. These agents assist in the dispersion of the microcapsules in water, and prevent microcapsule agglomeration. The listed dispersing agents also assist in the dispersion of suspended microcapsules when combined with the mixture of dry ingredients used to make the solid composition of the invention.

The microcapsule diameter ranges from about 100 nm to about 1,000 μm, generally from about 200 nm to about 50 μm, and typically from about 500 nm to about 20 μm.

In broad terms dry ingredients are blended together then combined with the liquid microcapsule suspension to form a moist mass suitable for extrusion.

The microcapsules may be mixed directly with dry ingredients. Generally the microcapsules are formulated as a “capsule suspension” (CS) prior to mixing with dry ingredients, i.e. the microcapsules are combined with rheology modifiers such as magnesium aluminium silicates (Veegum), xanthan gum, methyl cellulose, ethyl cellulose, etc, optionally further dispersing and/or wetting agents such as lignosulfonates, naphthalene sulfonates, polymeric dispersants, etc, as well as preservatives and water. This enables the capsule suspension to be manufactured and stored as a storage stable intermediate. Furthermore the addition to the microcapsules of the rheology agents magnesium aluminium silicates, xanthan gum, methyl cellulose, ethyl cellulose, and combinations thereof, has the additional benefit of providing the moist mass with an appropriate plasticity for extrusion.

According to an embodiment, in the method of manufacture, the solid, particulate formulation comprising a granule containing up to 5% moisture, is prepared by:

(A) Preparing a suspension comprising:
a microencapsulated volatile insecticide;
a binding agent;
a dispersing agent;
optionally a rheology modifier, and
   (B) Preparing a dry mixture by combining and thoroughly mixing dry ingredients comprising:
a bulking agent;
a disintegrating agent;
optionally a further binding agent;
optionally a further dispersing agent
   (C) Combining the microcapsule suspension (A) and the dry mixture (B) and mixing to produce a homogeneous moist mass;
   (D) Extruding the homogeneous moist mixture (C) to a diameter ranging from about 0.2 mm about 5 mm;
   (E) Spheronizing the extrudate; and
   (F) Reducing the moisture content by drying.

The ingredient quantities (where found) vary within the following ranges by weight of the final solid formulation: binding agent 2-20%, generally 3-17%, typically 4-15%; dispersing agent 2-20%, generally 3-18%, typically 5-15%; rheology modifier 0.1-15%, generally 0.5-12%, typically 0.1-5%; bulking agent 10-90%, generally 20-90%, typically 20-80%; disintegrating agents 2-40%, generally 4-30%, typically 5-20%.

The upper limit for the moisture content of the moist mass formed in step (C) is about 25%. If the moisture content is higher than 25%, it may be reduced by partial drying prior to extrusion. The ideal moisture content to achieve successful extrusion is dependent on the composition, and in particular the percentages of binding agent, dispersing agent and rheology modifier. Generally the moisture content of the moist mass is 6-20%, typically it is 10-20%. Generally, the soft moist mass is passed through a granulator/extruder screen having a diameter ranging from about 0.3 mm to about 3.0 mm or higher. Common sizes include 0.3, 0.5, 0.8, 1.0, 1.4, 2.0 and 3 mm screens.

The extruded material is next spheronized. In the absence of spheronization a pellet is formed that is liable to break up and produce fines during the drying step and when the solid formulation is drilled into soil.

After spheronizing and drying, the resulting solids are further screened to provide granules in the size range from about 100 μm to about 5 mm. Generally granule sizes range from about 200 μm to about 4 mm. Typical granule sizes range from about 0.5 mm to about 2 mm.

The moisture content of the granule ranges from about 0.5% to about 7%, generally 0.75% to 5%, typically from 1% to 4%.

Bulking agents (or “diluents”) include but are not limited to clays including various forms of Bentonite, Kaolin, etc, starches, lactose, calcium carbonate, calcium sulphate, calcium phosphate, etc, and mixtures thereof. Bulking agents, sometimes called diluents, provide sufficient mass to make the finished solid formulation a suitable size for convenient handling, or sized to match the size of the seeds with which the formulation may be drilled into soil.

Disintegrating agents include but are not limited to modified celluloses such as microcrystalline cellulose, modified starches such as sodium starch glycolate, crosslinked PVP, inorganic salts such as sodium sulphate, sodium citrate, etc, polycarboxylates, sodium phenylsulphonates, etc, or a mixture thereof. Disintegrating agents ensure partial disintegration of the solid formulation as it takes up moisture after incorporation into or onto soil, so as to allow the slow volatilization and/or release of microencapsulated volatile insecticidal active ingredients.

The use of disintegrating agents in the present invention is to be contrasted with a water dispersible granule (WG), a water soluble granule (SG) or an emulsifiable granule (EG) wherein the choice and quantities of disintegrating agent are such that these granules break up completely and release the granulated biocide into water within minutes ready for application by spraying. In the present invention the solid formulation when introduced into or onto soil is intended to undergo only partial disintegration and for that process to occur over a timeframe of days to months.

Optionally, powdered binding agents additional to the protective colloids of the microcapsule suspension may be added in dry form to the dry powder mixture. These include powdered polyvinyl pyrrolidone, oligosaccharides, sugar alcohols, and the like. Binding agents bind the various ingredients together to ensure the integrity of the solid formulation and reduce the production of fines during the manufacture of the solid formulation, and its packing, transport and delivery to the soil.

Optionally, powdered dispersing agents additional to the dispersing agents present in the microcapsule suspension may be added in dry form to the dry powder mixture. These include but are not limited to calcium, aluminium or sodium lignosulfonate, and sodium naphthalene sulfonate. Dispersing agents, whether derived from the microcapsule suspension and/or the dry mixture, ensure uniform distribution of microcapsules within the moist mass before formation of the solid formulation. Appropriately chosen dispersing agents also assist in the migration of slowly released insecticidal active ingredient within the soil.

Depending on the targeted final concentration of active ingredient it may be necessary to add water to the microcapsule suspension before mixing with dry ingredients in order to achieve a mass suitable for extrusion. Additionally water may be added together with binders in paste or gel form. Alternatively, and less typically, dried microcapsules may be mixed with dry ingredients prior to the addition of water and other ingredients.

Alternatively the dry ingredients may be mixed to homogeneity then combined with limited amounts of water (up to 25%, preferably less than 20%) and/or water-miscible solvents such as alcohols (up to 25%, preferably less than 20%) and glycols (up to 15%, preferably less than 10%), before addition and mixing in of the microcapsule preparation.

After further mixing to homogeneity the moist mass comprising dry ingredients and microcapsules is subject to some form of compression agglomeration, generally extrusion. The extruded material is further processed for example by spheronizing prior to drying. Any suitable method of drying may be used providing it does not lead to solids disintegration and product temperatures are controlled to prevent undue volatilisation of active ingredient.

Alternative agglomeration methods are known in the art, for example pan granulation whereby premixed powdered ingredients are fed into a rotating pan and the aqueous suspension of microcapsules is sprayed on to the mixture to form spherical granules that are built up by the rolling motion at the circumference of the pan. Further detailed methods for making granules are provided in the examples below.

The preferred method of tablet manufacture involves mixing dry ingredients, “wet granulation”, drying and compression. According to this method a dry powder blend is prepared by mixing to homogeneity fillers or bulking agents such as starch, carboxymethyl cellulose, calcium phosphate dihydrate, lactose, mannitol, etc, binders such as hydroxypropyl cellulose, microcrystalline cellulose, starches, etc, and lubricants such as silica or talc. The microencapsulated insecticide is added at this point as either the wet microcapsule suspension or as a dried preparation. Wet granulation is performed in a mass mixer by adding further, pre-gelled, binders, in particular starch or hydroxypropyl cellulose, in order to rope out and granulate the solids. The granulated mixture is then dried in a fluid bed or tray drier, sieved, and compressed in a tablet machine to the desired tablet size and density. In an alternative tableting method dried microcapsules and other dry ingredients are combined with a compressible powder such as compressible lactose, then tableted.

The preferred method of bait manufacture involves the mixing of dry base materials, generally edible, and including ground wheat, bran, rice husks, corn cob grits, etc, together with binding agents, and optionally preservatives, waterproofing agents and attractants such as sugars, oils or protein mixtures, followed by the addition of water to form a wet mass that is extruded under pressure as a pellet, generally larger than about 1 mm in diameter, and dried. The insecticide containing microcapsule may be added in dried form but preferably is added as a wet microcapsule suspension in place of or in combination with water.

In addition to insecticidal active ingredients, the final composition may contain 0.1% to 99% by weight of customary formulation additives. Customary formulation additives and their functions are described in the previously mentioned publications and are common to the art. Such additives may include water, agriculturally suitable surfactants, dispersants, emulsifiers, penetrants, spreaders, wetting agents, soaps, carriers, oils, solvents, diluents, inert components, conditioning agents, colloids, suspending agents, thickeners, thixotropic agents, polymers, emollients, acids, bases, salts, organic and inorganic solid matrices of various kinds, preservatives, anti-caking agents, lubricants, stickers, binders, glues, resins, complexing agents, chelating agents, crystallization inhibitors, dyes, activators, synergists, UV protectants, fertilizers, micronutrients, and the like.

Optionally the solid, particulate formulation may include one or more attractants suitable for attracting the targeted insect pests. Generally, when the attractants are added, the solid formulation functions as a bait.

The solid, particulate formulation may optionally also contain further agrichemical active ingredients selected from a fungicide and/or a nematicide.

The solid, particulate formulation comprising a granule, a bait or a tablet may be manufactured to any size that is appropriate for the crop to be protected and the application equipment available.

Preferably the weight is in the range from about 0.1 mg to about 1 gram, more preferably in a weight range approximating that of the common pasture and crop seeds, i.e. from approximately 0.2 mg to approximately 100 mg. Preferably the solid formulation is relatively dense with a low rate of disintegration in a moist soil environment.

Typically, the solid, particulate formulation is a granule.

The invention provides a method of controlling insects in soil, which comprises mechanically applying to soil, insecticidally effective amounts of the composition of the invention.

Preferably the composition is mechanically incorporated into soil, i.e. below the soil surface, but it may also be broadcast onto the soil surface.

The method is applicable to any field or vegetable cropping situation where control is required for soil dwelling insects or insect life stages, or for soil sheltering insects. The method is particularly useful when combined with sowing or transplant operations but can also be used with mature crops, particularly established pasture.

Depending on equipment available the composition may be applied during sowing operations either mixed with seed or applied via a separate delivery system. A wide range of drilling, tilling or cultivation methods and equipment may be used to incorporate the composition into soil with or without seeds or transplanted seedlings. It is particularly advantageous to place the insecticide formulation in the vicinity of seeds or transplanted seedlings, for example positioned directly in the seed or transplant row. Alternatively the composition may be applied separately to the seed bed either before or after sowing. Various drilling methods may be used to introduce the formulation into the soil of crops at any stage of the crop cycle including crop maturity. Other known methods of soil incorporation may be contemplated, for example broadcasting granules onto the soil surface prior to cultivation. In some situations the composition may be applied onto the soil surface in the vicinity of freshly transplanted, emergent or mature crop.

When the solid, particulate formulation of the invention is applied “down the spout” during drilling operations it is desirable to obtain a reasonably close match between the size and density of the formulation and the size and density of the seeds.

Insects that may be controlled by the formulation include pasture and crop pests including, but not limited, to New Zealand grass grub (Costelytra zealandica), porina (Wiseanai spp.), Tasmanian grass grub (Aphodius tasmaniae Hope), underground grass grub, white curl grub or cockchafer (various scarab species), false wireworm in canola, cereals, cotton and soybeans, sugarcane grubs, several types of wireworms in various crops including potatoes, alfalfa, corn, peanuts, soybean and sugar beet, various cutworms in a wide range of crops including alfalfa, corn, peanuts, sorghum, soybean, sugarbeet, sunflower and tobacco, root maggots in vegetable and forage brassicas, vegetables and sugarbeet, bloodworms in rice, crickets, earwigs and cockroaches.

The formulation may be applied at a rate ranging from about 100 grams active ingredient per hectare (gai/ha) to about 5,000 gai/ha, depending on the insecticide, the method of application, the pest, the crop, the density and pattern of seedling or planting of the crop and whether the composition is applied as a preventative or salvage operation.

Preferably the formulation is applied at a rate ranging from about 200 gai/ha to about 3,000 gai/ha, still more preferably from about 500 gai/ha to about 2,000 gai/ha.

A person of ordinary skill in the art will acknowledge the value of product label claims and directions for use in determining suitable applications and use rates for the compositions of this invention.

The following examples and the particular proportions set forth are intended to be illustrative only and are thus non-limiting.

EXAMPLE 1. Chlorpyrifos microcapsule preparations.

| | Microcapsule preparation | | | | | |
|---|---|---|---|---|---|---|
| | 1 | 2 | 3 | 4 | 5 | 6 |
| Ingredient | g | g | g | g | g | g |

Organic phase

| | | | | | | |
|---|---|---|---|---|---|---|
| Chlorpyrifos | 48.75 | 52.0 | 52.1 | 52.2 | 52.1 | 51.2 |
| (97.6%) | | | | | | |
| Aromatic 200 | — | 14.0 | 17.5 | — | 22 | 5.8 |
| Hyvis 5 | — | 7.0 | 3.5 | — | — | — |
| Hikotack P-120 | — | — | — | — | — | 1.7 |
| Break-thru OE | — | — | — | — | — | 1.7 |
| 441 | | | | | | |
| pMDI | 1.25 | 1.9 | 1.9 | 2.7 | 1.9 | 1.6 |

Aqueous phase

| | | | | | | |
|---|---|---|---|---|---|---|
| Water | 41.61 | 40.34 | 38.91 | 32.04 | 36.76 | 34.0 |
| PVA | 2.25 | 4.75 | 5.7 | 6.21 | 7.13 | 1.8 |
| Na | 1.125 | 2.375 | 2.85 | 3.11 | 3.56 | 0.9 |
| Lignosulfonate | | | | | | |
| Antifoam RD | 0.002 | 0.005 | 0.006 | 0.006 | 0.007 | 0.003 |
| Kathon LX | 0.014 | 0.029 | 0.034 | 0.037 | 0.043 | 0.02 |

Crosslinker

| | | | | | | |
|---|---|---|---|---|---|---|
| Water | 4.7 | 0.9 | 0.9 | 2.2 | 0.9 | 0.8 |
| DETA | 0.52 | 0.62 | 0.62 | 1.48 | 0.62 | 0.5 |
| Total g | 100.20 | 123.94 | 124.04 | 100.00 | 125.04 | 100.00 |
| Chlorpyrifos | 47.5% | 40.9% | 41.0% | 50.9% | 40.7% | 50.0% |
| concentration | | | | | | |
| Volume mean | 3.99 | 3.25 | 2.16 | 1.0 | 1.19 | 5.25 |
| diameter (μm) | | | | | | |

Chlorpyrifos was either melted at 50° C. for 1 hour and weighed into a pre-warmed beaker or dissolved in Aromatic 200 and combined with various combinations of Hyvis 5 (polyisobutylene, BP Chemicals), Hikotack P-120 (aromatic hydrocarbon resin, Kolon Industries), OE 441 and pMDI to prepare the organic phase. Aqueous phase was prepared by diluting a stock solution, and added to the organic phase over a 90 second period under high shear conditions (Ultra-Turrax mixer) to prepare an oil-in-water emulsion. The emulsion was combined with DETA to form the microcapsule wall, stirred gently for 10 min then left to stand overnight to cure before measuring microcapsule diameter using a Malvern MAF5000 Mastersizer.

A stable microcapsule suspension (6A) was made by combining with gentle mixing the following ingredients by weight: microcapsule preparation 6: 101.5 g, magnesium aluminium silicate 0.24 g, sodium naphthalene sulfonate 0.38 g, acrylic graft copolymer dispersant 0.5 g, xanthan gum 0.01 g and water 4.2 g.

### Example 2. Chlorpyrifos Granule Formulations

| | Granule preparation | | | | | | | |
|---|---|---|---|---|---|---|---|---|
| | 1 | 2 | 3 | 4 | 5 | 6 | 7 | 8 |
| | Microcapsule prep. (Ex 1) | | | | | | | |
| | 3 | 2 | 6 | 1 | 5 | 4 | 4 | 6A |
| Ingredient | g/kg | g/kg | g/kg | g/kg | g/kg | g/kg | g/kg | g/kg |
| Kaolin | 450 | 600 | 400 | 200 | 100 | 100 | 150 | 427 |
| Bentonite | 125 | — | — | — | 320 | 300 | 50 | |
| Na Naphthalene sulfonate | 100 | 100 | — | — | — | — | — | 109 |
| Ca Lignosulfonate | — | — | 100 | 100 | 80 | 100 | 100 | |
| Microcrystalline cellulose | 100 | — | 100 | 400 | — | 100 | 200 | 106 |
| Water | 100 | 50 | — | — | — | — | — | |
| Chlorpyrifos microcapsule | 125 | 250 | 400 | 300 | 500 | 400 | 500 | 358 |
| Chlorpyrifos conc. before | 51 | 102 | 200 | 142 | 203 | 204 | 255 | 168 |
| extrusion & drying (gai/kg) | | | | | | | | |

Dry ingredients were mixed for 10 minutes in a 5 litre blade action mass mixer at a speed of 2,300 rpm. The microcapsule preparation (and water) was then added over 20-25 minutes with the blade speed of 50-150 rpm, depending on the consistency of the mixture. The resulting soft moist mass was passed through a granulator/extruder fitted with a 1.0, 1.4 or 2.0 mm screen, then dried in a tray drier at 40° C. and screened to provide granules in the size range 750 μm to 2 mm.

It will be appreciated that the preferred compositions provided in the examples are examples only and that other insecticidal compositions may be contemplated comprising one or more microencapsulated insecticidal active ingredients having a vapour pressure at 25° C. in the range from about 1 mPa to about 1,000 mPa, and a water solubility at 25° C. less than about 100 mg/Litre that is combined with dry ingredients and processed mechanically to produce a solid formulations suitable for incorporation into or onto soil.

### Example 3. Grass Grub Control in Existing Pasture

Granule preparation 3 (Example 2) was applied to an established pasture at Glenroy Canterbury consisting of perennial ryegrass (Lolium perenne) and white clover (Trifolium repens) showing characteristic signs of grass grub damage and heavily infested with approximately 500 grubs per square metre. The trial was performed using a randomised block design with four replicates of plots measuring 7.2 m×30 m. Treatments were applied to soil using a tine drill in mid winter. Grass grub larvae were counted in six 0.15 m² spade samples at drilling and 307 days later and mean counts compared by ANOVA (Table 1). The granule containing microencapsulated chlorpyrifos applied at rates of 450 gai/Ha and 900 gai/Ha provided similar control to a comparison product SuSCon Green, a granule comprising non-encapsulated chlorpyrifos within a plastic matrix, applied at chlorpyrifos rates 1.66-fold higher. Even the low rate of microencapsulated chlorpyrifos provided better control than a conventional diazinon soil granule at a rate of 1100 gai/Ha.

| | Rate | Grubs per m² | | % Control |
|---|---|---|---|---|
| Treatment | (gai/Ha) | 0 days | 307 days | (Abbotts) |
| Granule prep 3 (micro | 450 | 511 | 137 c | 76 ab |
| encapsulated chlorpyrifos) | | | | |
| Granule prep 3 (micro | 900 | 635 | 83 c | 85 a |
| encapsulated chlorpyrifos) | | | | |
| SuSCon Green (chlorpyrifos) | 750 | 511 | 131 c | 77 ab |
| SuSCon Green (chlorpyrifos) | 1500 | 511 | 100 c | 82 a |
| Diazinon 20G | 1100 | 502 | 339 b | 40 b |
| Untreated | — | 533 | 563 a | 0 c |
| LSD (P = 0.05) | | NS | 107 | 30.5 |

Means followed by the same letter do not differ significantly (P=0.05, Duncan's New MRT).

### Example 4. Grass Grub Control in New Pasture

New pasture was sown on sprayed out land at Hororata Canterbury in early autumn. Chlorpyrifos granules were applied down the spout (rates in table) with perennial ryegrass seed (26 kg/Ha) using a small tine drill to establish a trial using a randomised block design with four replicates of plots measuring 4.8 m×20.4 m. At sowing the population was estimated at 173 grubs/m², which is sufficient to cause considerable pasture damage. At 120 days the 880 gai/Ha rate of granule prep 3 produced over 75% control (over and above a natural decline in grass grub population, significant at P=0.1 but not at P=0.05). A further count at 173 days demonstrated the same control, significant at P=0.05. All treatments produced significant increases in pasture measured at 120 and 173 days.

| | | 120 days | | 176 days | |
|---|---|---|---|---|---|
| | Rate | Grubs | % Grass | Grubs | % Grass |
| Treatment | (gai/Ha) | per m2 | volume | per m2 | volume |
| Granule prep 3 (micro | 440 | 53 | 77 a | 12.5 a | 85 a |
| encapsulated | | | | | |
| chlorpyrifos) | | | | | |
| Granule prep 3 (micro | 880 | 17 | 86 a | 7.5 a | 84 a |
| encapsulated | | | | | |
| chlorpyrifos) | | | | | |
| SuSCon Green | 750 | 13 | 85 a | 5.0 a | 89 a |
| (chlorpyrifos) | | | | | |
| Untreated | | 70 | 49 b | 30.0 b | 49 b |
| LSD (P = 0.05) | | 47.8 | 19.6 | 15.0 | 11 |

Means followed by the same letter do not differ significantly (P=0.05, Duncan's New MRT).

### EQUIVALENTS CLAUSE

The Invention may also broadly be said to consist in the parts, elements and features referred or indicated in the specification, individually or collectively, and any or all combinations of any of two or more parts, elements, members or features and where specific integers are mentioned herein which have known equivalents such equivalents are deemed to be incorporated herein as if individually set forth.

### MODIFICATIONS AND VARIATIONS

The invention has been described with particular reference to certain embodiments thereof. It will be understood that various modifications can be made to the above-mentioned embodiment without departing from the ambit of the invention. The skilled reader will also understand the concept of what is meant by purposive construction.

The examples and the particular proportions set forth are intended to be illustrative only and are thus non-limiting.

Throughout the description and claims of the specification the word “comprise” or variations thereof are not intended to exclude other additives, components or steps.

1. A solid particulate insecticidal formulation which is formulated to be mechanically incorporated into or onto soil, the formulation comprising:
i. a microencapsulated volatile insecticide selected from insecticidal active ingredients having:
(a) a vapour pressure at 25° C. in the range from about 1 mPa to about 1,000 mPa; and
(b) a water solubility at 25° C. less than about 100 mg/Litre;
ii a bulking agent; and
iii. a disintegrating agent.

2. The formulation according to claim 1, further comprising:
iv. a binding agent, and/or
v. a dispersing agent.

3. The formulation according to claim 2, further comprising:
vi. a rheology modifier.

4. The formulation according to claim 1, wherein the formulation is formulated as a granule, a bait, or a tablet.

5. The formulation according to claim 4, wherein the formulation is formulated as a granule.

6. The formulation according to claim 2, wherein the volatile insecticidal active ingredient is selected from chlorethoxyfos, chlorpyrifos, chlorpyrifos-methyl, diazinon, dichlorvos, disulfoton, fenitrothion, fenthion, phorate, pirimiphos-methyl, tebupirimfos, tefluthrin, terbufos, thiodicarb, and a mixture thereof.

7. The formulation according to claim 1, wherein the microencapsulated volatile insecticide has a mean microcapsule diameter from about 100 nm to about 1,000 μm.

8. The formulation according to claim 7, wherein the mean microcapsule diameter is from about 200 nm to about 50 μm.

9. The formulation according to claim 8, wherein the mean microcapsule diameter is from about 500 nm to about 20 μm.

10. The formulation according to claim 1, wherein the microencapsulated volatile insecticide is a blend of two microcapsules, each containing a different active ingredient.

11. The formulation according to claim 1, wherein the formulation contains from 0.1% to 50% by weight of the insecticidal active ingredient based on the total weight of the formulation.

12. The formulation according to claim 2, wherein the:
ii. bulking agent is selected from clays, starches, lactose, calcium carbonate, calcium sulphate, calcium phosphate, and a mixture thereof; and
iii. disintegrating agent is selected from microcrystalline cellulose, sodium starch glycolate, crosslinked PVP, sodium sulphate, sodium citrate, polycarboxylates, sodium phenylsulphonates, and a mixture thereof.

13. The formulation according to claim 3, wherein the
ii. bulking agent is selected from clays, starches, lactose, calcium carbonate, calcium sulphate, calcium phosphate, and a mixture thereof;
iii. disintegrating agent is selected from microcrystalline cellulose, sodium starch glycolate, crosslinked PVP, sodium sulphate, sodium citrate, polycarboxylates, sodium phenylsulphonates, and a mixture thereof;
iv. binding agent is selected from polyvinyl alcohol, polyvinyl pyrrolidone, polyvinyl acetate copolymers, polyacrylate, gelatine, polyacrylamide, oligosaccharides, sugar alcohols, lecithin, and a mixture thereof; and
v. dispersing agent is selected from calcium, aluminium or sodium lignosulfonate, sodium naphthalene sulfonate, polymeric dispersants, and a mixture thereof.

14. The formulation according to claim 13, further comprising
vi. a rheology modifier selected from magnesium aluminium silicates, xanthan gum, methyl cellulose, ethyl cellulose, and a mixture thereof.

15. The formulation according to claim 14, wherein the solid formulation comprises 10-80% by weight of the bulking agent, 2-20% by weight of the disintegrating agent, 2-20% by weight of the binding agent, 2-20% by weight of the dispersing agent, and 0.1-15% by weight of the rheology modifier.

16. The formulation according to claim 1, wherein the microencapsulated volatile insecticidal active ingredient is supplemented with a different insecticidal active ingredient having a mode of action other than vapour phase activity.

17. The formulation according to claim 16, wherein the supplementary active ingredient is root absorbed and systemically active, and is soluble in a water-immiscible solvent appropriate for microencapsulation.

18. A method for producing a solid particulate insecticidal formulation according to claim 1, said method comprising:
(A) preparing a suspension by combining components comprising a microencapsulated volatile insecticide selected from insecticidal active ingredients having:
(a) a vapour pressure at 25° C. in the range from about 1 mPa to about 1,000 mPa, and
(b) a water solubility at 25° C. less than about 100 mg/Litre; and
iv. a binding agent;
v. a dispersing agent; and
vi. optionally a rheology modifier;
(B) preparing a dry mixture by combining and thoroughly mixing dry ingredients comprising:
ii. a bulking agent; and
iii. a disintegrating agent;
(C) combining the microcapsule suspension (A) and the dry mixture (B) and mixing to produce a homogeneous moist mass;
(D) extruding the homogeneous moist mass (C) to a diameter ranging from about 0.2 mm about 5 mm to form an extruded mass; and
(E) reducing the moisture content of the extruded mass by drying.

19. The method according to claim 18, wherein the dry mixture (B) optionally further comprises a dry binding agent and/or a dry dispersing agent.

20. The method according to claim 18, further comprising spheronizing the extruded mass prior to drying.

21. A method of treating soil to minimise insect attack from soil dwelling insects on planted seeds, growing plants and/or mature plants by incorporating into the soil or applying onto the soil a solid particulate insecticidal formulation according to claim 1 in the form of a granule, a bait, or a tablet.

22. The method according to claim 21 wherein the formulation is applied at a rate of from about 200 grams gai/ha to about 3,000 gai/ha.

23. The method according to claim 21, wherein the formulation is applied at the time of drilling or planting, or at any subsequent stage of the crop or pasture growth cycle.
